(19) United States
(12) Patent Application Publication
(10) Pub. No.: US 2008/0210774 A1
(43) Pub. Date: Sep. 4, 2008

(54) APPARATUS AND METHOD FOR HUMIDIFYING A NOZZLE OF A COLORANT DISPENSER

(75) Inventors: Jami Shon Dale, Charlotte, NC (US); James Howard Merritt, Waxhaw, NC (US); Steven Marshall, Fort Mill, SC (US); Martin Miguel Salas, Charlotte, NC (US)

Correspondence Address: ADAMS INTELLECTUAL PROPERTY LAW, P.A., Suite 2350 Charlotte Plaza, 201 South College Street, CHARLOTTE, NC, 28244, US

(73) Assignee: ULTRABLEND, LLC, Charlotte, NC (US)

(21) Appl. No.: 12/037,163

(22) Filed: Feb. 26, 2008

Related U.S. Application Data
(60) Provisional application No. 60/892,651, filed on Mar. 2, 2007.

(51) Int. Cl. B05B 15/02

(52) U.S. Cl. 239/112

(57) ABSTRACT

An apparatus for providing vapor to at least one liquid dispensing nozzle to prevent liquid at the nozzle tip from drying out between uses. The apparatus comprises a water source, a reservoir, a vapor generating source for generating vapor from water, a chamber for maintaining the vapor, and an opening defined through a chamber wall for exposing the at least one nozzle to the vapor when the at least one nozzle is in a storage position between uses.

### CROSS-REFERENCE TO RELATED APPLICATIONS

The present invention claims priority to U.S. Provisional Patent Application No. 60/892,651 filed Mar. 2, 2007 and entitled “APPARATUS AND METHOD FOR HUMIDIFYING A COLORANT-DISPENSING NOZZLE OF A COLORANT DISPENSER”.

### TECHNICAL FIELD AND BACKGROUND OF THE INVENTION

The present invention relates generally to an apparatus and method for maintaining the proper operation of a colorant dispensing apparatus, and more particularly, to an apparatus and method for supplying humidity to the area around a colorant-dispensing nozzle to prevent colorant at the nozzle tip from drying out between uses.

Paint retailers typically use colorant dispensing apparatus to precisely add colorant to a base paint to arrive at a desired custom color. Conventional colorant dispensers typically include a variety of source colorants stored in reservoirs within the apparatus, one or more nozzles for precisely dispensing the colorant into the base paint, and a plurality of feed tubes for withdrawing the colorants from the reservoirs and delivering them to the one or more nozzles. The process of creating a custom color begins when a user selects a certain color. The dispenser then determines which source colorants and in what amounts are required to achieve the custom color. Once determined, the colorants are then drawn from the reservoirs through the plurality of feed tubes and dispensed into the container of base paint through the nozzles. After the colorant has been added to the base paint, the paint container is then typically transferred to another apparatus where the container is shaken and the paint agitated to thoroughly mix the colorant into the base paint to provide an even custom color.

In conventional dispensers, the colorants were typically suspended in dispersants such as oils or glycols. These colorants tend to be slow-drying, and therefore, colorant at the tip of the dispensing nozzle tended to dry relatively slowly. Thus, if the dispensing apparatus was not used for several hours or even days, the colorant at the nozzle tip would remain sufficiently liquid so as not to plug the nozzles or dispense dried bits of colorant into the base paint at the next use.

In recent years, as a result of environmental concerns, volatile dispersants have been reduced or eliminated from many colorants in favor of water-based dispersants. These water-based dispersants tend to dry very quickly, so that even a few hours of non-use can cause colorant in the dispensing nozzle to harden, either plugging the nozzle or causing a hardened particle of colorant to be ejected into the base paint, thus decreasing the ability of the colorant dispensing machine to precisely control the amount of colorant dispensed. An imprecise amount of colorant typically causes the paint to be “off color” and therefore rejected by the purchaser, resulting in wasted paint, customer dissatisfaction and lost profits.

One conventional method of preventing the hardening of the residual colorant at the nozzle tip includes placing a damp sponge in the vicinity of the nozzle to humidify the area through evaporation. Disadvantages of this method are a user must remember to dampen the sponge, the sponge only holds a limited amount of moisture and will dry out in a short period of time, and the method has a slow humidity recover time and is highly sensitive to ambient temperatures. Another conventional method is disclosed in U.S. Pat. No. 6,843,431, in which an apparatus is provided that includes a moist gas generating element, a supply hose for actively delivering the moist gas, and a gas containment space around the nozzle. Disadvantages of this method are its slow recovery time, dependence on ambient temperature, and the complexity and expense of an extra nozzle and dedicated supply hose. Another disadvantage to this device is that it requires modification to the nozzle array as well as other components for installation, and thus does not lend itself to retrofit applications.

Thus, there is a need for a less complex, reliable, retrofitable and essentially operator-free apparatus for maintaining a humid environment capable of high vapor density generation at the nozzle area of a colorant dispenser to prevent colorant at the nozzle tip from drying out between uses.

### SUMMARY OF THE INVENTION

In various embodiments, the present invention provides apparatus and methods for maintaining a humid environment about one or more nozzles of a colorant dispensing apparatus to prevent colorant at the nozzle tip from drying out between uses.

In one embodiment, the present invention provides a liquid dispensing apparatus including a water vapor generating source for creating a humid environment about a colorant dispensing nozzle to prevent the colorants from drying out between uses.

In another embodiment, the present invention provides a colorant dispenser including an apparatus for supplying humidity to at least one nozzle tip between uses, wherein the apparatus is mounted to the dispenser and includes a water source, a reservoir for maintaining a predetermined volume of water, a heat source for heating the volume of water to stabilize the reservoir environment relative to ambient, to enhance water vapor density, and a partial barrier allowing water vapor to reach at least one colorant dispensing nozzle tip between uses., without drips contaminating the reservoir water.

In further embodiments, the apparatus may include a set of seals that seal off the reservoir and prevent water vapor from escaping the apparatus during periods of nozzle use. The apparatus may further include one or more of a water bottle, a water level monitoring window, a humidity sensor, an apparatus controller, a drain, a water level switch and an inlet for receiving water from an external water source. The apparatus is preferably a closed-loop system that maintains pre-selected temperature, humidity and water levels. Depending on the ambient environment, a pre-selected temperature without relative humidity monitoring (i.e., an open loop control) is an alternative embodiment.

In yet another embodiment, the present invention provides a colorant dispensing apparatus that includes a humidity generating apparatus for supplying water vapor to at least one colorant dispensing nozzle tip, wherein the apparatus includes a water vapor generating device, a water reservoir for maintaining water, and a path for passively supplying water vapor from the water vapor generating device to the at least one nozzle tip between uses.

In further embodiments, the apparatus may include a set of seals for preventing water vapor escape while dispensing, a water level monitoring window, a drain, a water level switch, and an inlet for receiving water from an external water source. The apparatus may further include a bulkhead spaced apart from a bottom of the reservoir for partially separating the water reservoir into a supply section and a water vapor generating section while allowing some water to flow from the supply section to the water vapor generating section, without allowing water vapor to flow into the water supply section. The apparatus may further include a pivoting plate for moving the nozzle between a dispensing position and a storage position in which a portion of the nozzle is stored within the sealed area and exposed to the water vapor. Humidity levels are preferably detected using a humidity sensor positioned about the nozzle tip. The apparatus typically uses a controller that receives an output reading from the sensor and turns on/off the water vapor generating device as needed to maintain a predetermined humidity level (i.e. close loop control). The apparatus may optionally include a drain tube for draining condensation from the flow channel to a waste tank.

In yet another embodiment, the present invention provides a colorant dispensing apparatus that includes an integrated apparatus for supplying water vapor to at least one nozzle tip between uses.

In yet another embodiment, the present invention provides a water vapor generating kit that may be retrofitted to existing colorant dispensers to create a humid environment around at least one nozzle tip between uses.

The various embodiments preferably include an apparatus for moving the nozzle or a nozzle cover between a dispensing position in which the nozzle tip is not exposed to the water vapor, and a storage position in which the nozzle tip is exposed to water vapor. When the nozzle is in the dispensing position, the humidifying apparatus is preferably sealed off from the environment to prevent moisture loss.

### BRIEF DESCRIPTION OF THE DRAWINGS

While some of the embodiments and advantages of the invention have been set forth above, other embodiments and advantages of the invention will appear as the description of the invention proceeds when taken in conjunction with the following drawings, in which:

FIG. 1 is a perspective view of a colorant dispenser including a humidifying apparatus according to an embodiment of the invention;

FIG. 2 is a partial cut-away perspective view of the humidifying apparatus shown in FIG. 1;

FIG. 3 is a perspective view of the humidifying apparatus shown in FIG. 1 illustrating sealing and a heating element;

FIGS. 4-5 are perspective views of the humidifying apparatus shown in FIG. 1 removed from the colorant dispenser;

FIG. 6 is a cross-sectional view of the humidifying apparatus shown in FIG. 1;

FIG. 7 is a perspective view of a colorant dispenser including an alternative humidifying apparatus according to another embodiment of the invention;

FIGS. 8-9 are perspective views of the humidifying apparatus shown in FIG. 7 removed from the colorant dispenser;

FIG. 10 is a side perspective view of a portion of the colorant dispenser of FIG. 7 illustrating the water vapor flow path.

FIGS. 11-12 are perspective views of the humidifying apparatus shown in FIG. 7 and a portion of the colorant dispenser;

FIG. 13 is a perspective view of a portion of the colorant dispenser of either FIG. 1 or 7 shown with the nozzle portions in a storage position and exposed to vapor; and

FIG. 14 is a perspective view of a portion of the colorant dispenser of either FIG. 1 or 7 shown with the nozzle portions in a dispensing position and not exposed to vapor.

### DESCRIPTION OF THE PREFERRED EMBODIMENTS AND BEST MODE

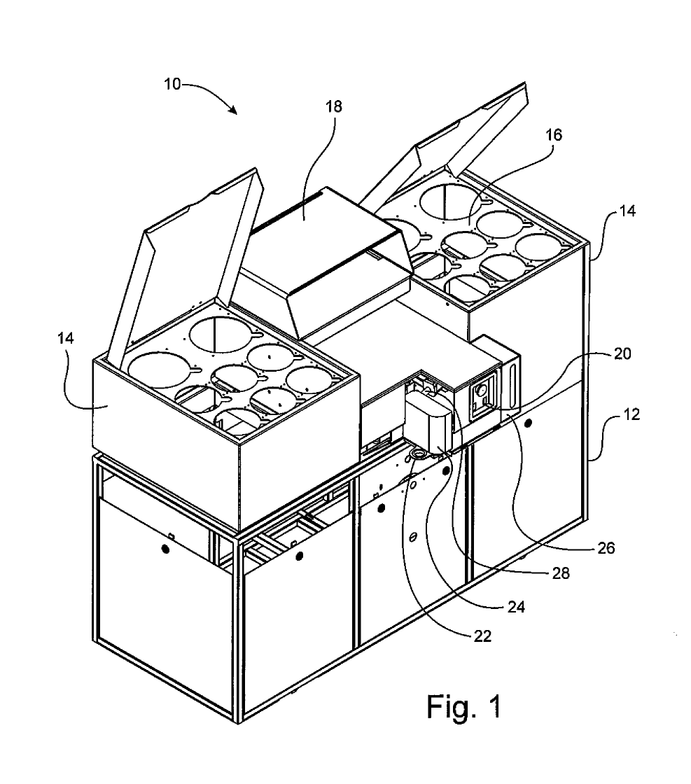

Referring now to the drawings, a colorant dispenser according to a preferred embodiment of the present invention is shown in FIG. 1 at 10. The dispenser includes, among other components and features not essential to describe the present invention, a body (base) 12, at least one canister bay 14 for housing a predetermined number of colorant canisters, for example 16 canisters maintained in canister locations 16. The dispenser 10 further includes a computer shelf 18 for supporting a computer (not shown) that is used to control the operation of the dispenser. The computer includes pre-loaded software, such as ColorCreator™ software available from Ultrablend of Charlotte, N.C., for selecting colorants, precise dispensing control, and diagnostics and maintenance capabilities. The dispenser 10 further includes a control panel 20 for dispensing colorant into a property positioned base paint container and a container alignment feature 22, also referred to herein as “Bombsight™”, for aligning the container relative to the dispensing nozzles positioned within a nozzle shroud 24. The dispenser 10 further includes a humidity-generating apparatus 26 for exposing the nozzles to vapor when the nozzles are not in use. The nozzles are capable of being selectively moved between a dispensing position and a storage position by an actuator 28.

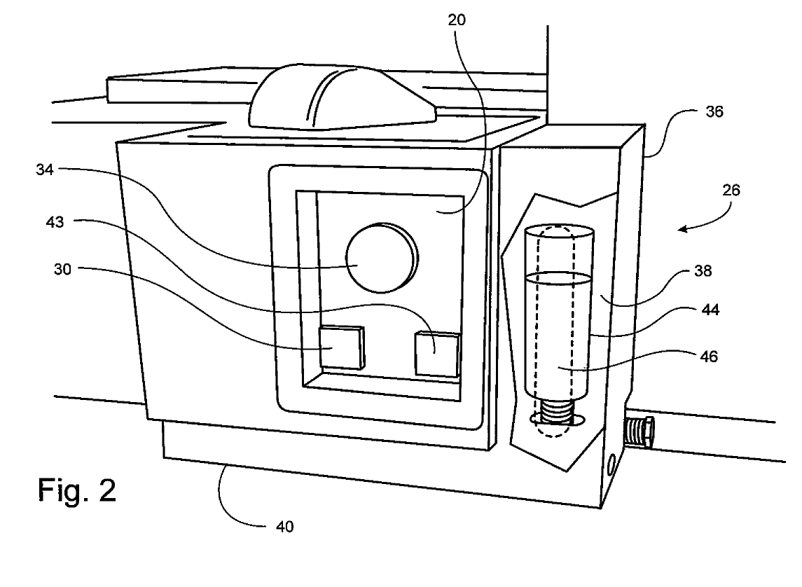

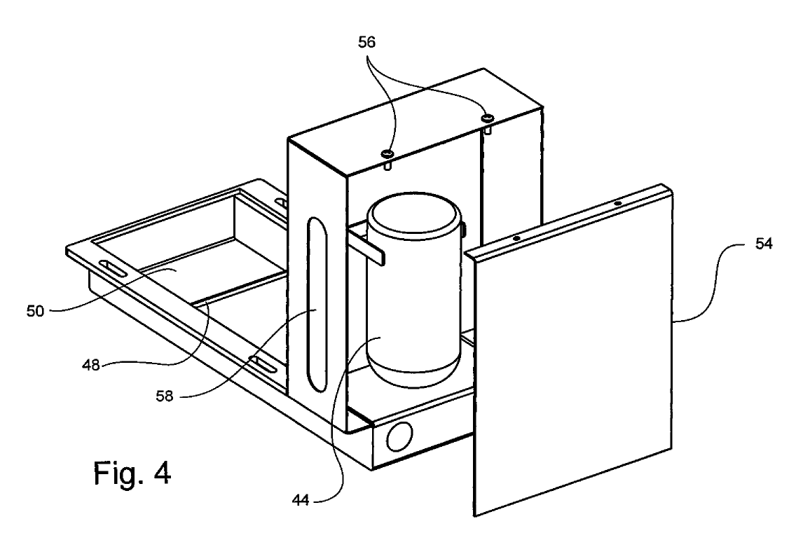

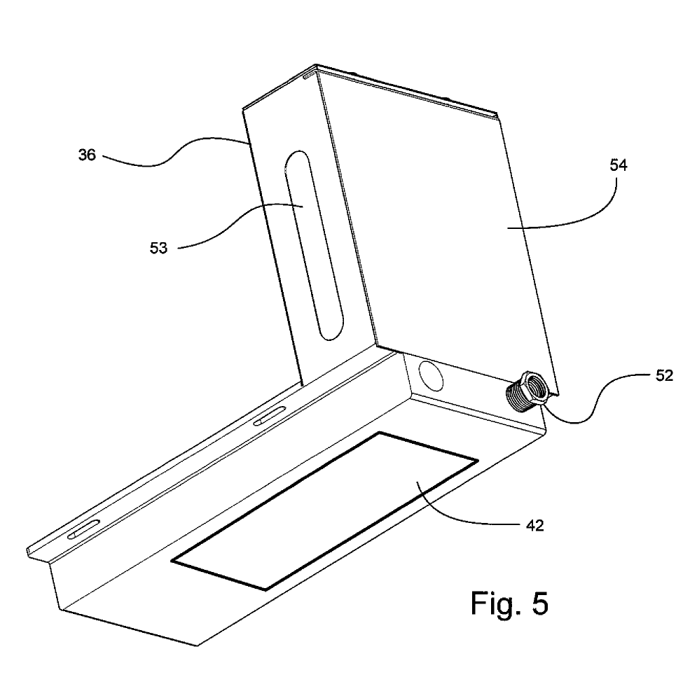

Referring to FIGS. 2-6, detailed views of the humidity-generating apparatus 26 are shown. The apparatus is shown positioned about the control panel 20 which includes various buttons including, but not limited to, dispense 30, jog 32 (move between dispense and storage positions), and emergency stop 34. The apparatus may be provided mounted to the dispenser, however, in alternative embodiments, may be sold as an add-on kit and mounted to existing colorant dispensers with simple modification to the dispenser. Suitable examples of colorant dispensers that may include humidity-generating apparatus are the TruBlend XT, Mini-XT and XM models available from Ultrablend. The apparatus 26 includes a housing 36 that defines a first chamber 38 for maintaining a water source therein, and a tray 40 for maintaining a predetermined volume of water supplied by the water source. A heating source 42, such as a heating pad, is in thermal contact with a bottom surface of the tray 40 and heating the volume of water in the tray to a pre-selected temperature, thus producing vapor. The heating source 42 also functions to stabilize the temperature in the humidity zone about the nozzles in their storage position and stabilizes the temperature of the tray 40.

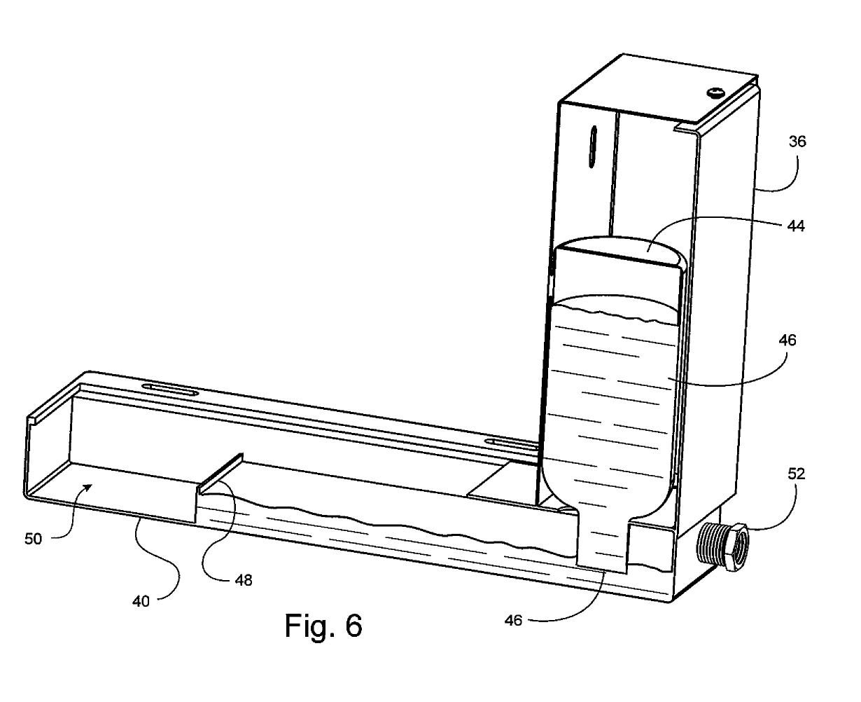

As shown, the water source is a water bottle 44 having any shape or size suitable for holding a volume of water 46, for example, about 1-3 weeks worth of water before requiring refilling. The volume of water creates a positive pressure that causes the water 46 to ingress into the tray 40. Referring specifically to FIG. 6, water in the tray is heated to produce vapor that rises and passively travels over a bulkhead 48 defined by the tray and into a second chamber 50 defined by the tray 40 in which the nozzles are exposed to the vapor between periods of use. The apparatus may further include an inlet 52 for supplying water from an external water source such as a supply hose. The inlet 52 may further function as a drain. The tray 40 may include a drain located in the bottom surface of the second chamber 50 to remove water from drip collection. The apparatus further preferably defines a housing lid 54 secured to the housing using one or more conventional fasteners 56 that can be removed to provide access to the water bottle 44. The housing 36 also preferably defines a window 58 therethrough for viewing the water level in the bottle.

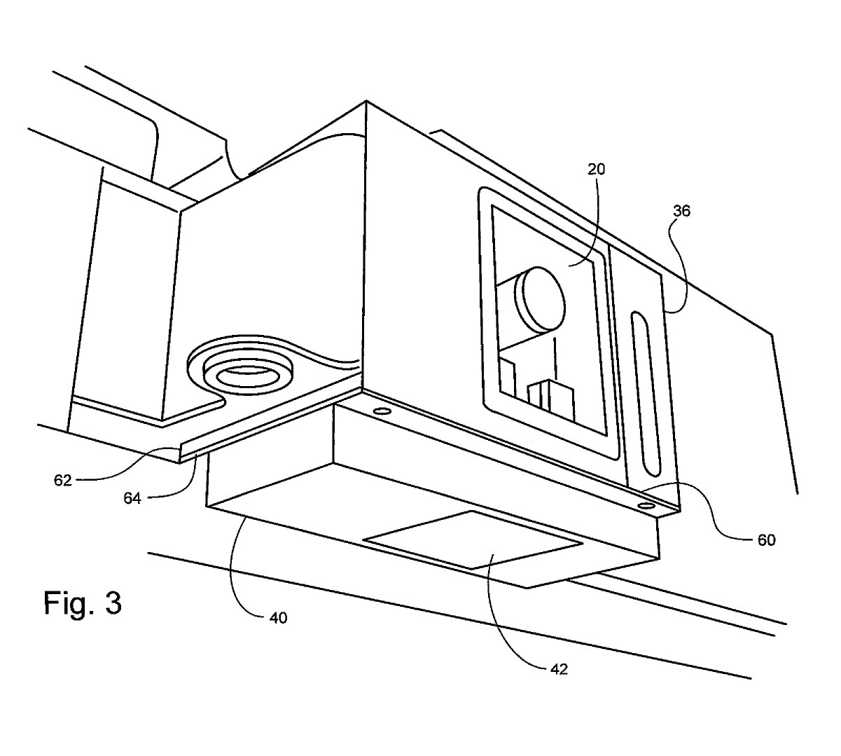

Referring specifically to FIG. 3, a tray seal 60 is positioned between the bottom surface of the control panel 20 and the top surface of the apparatus tray 40 for sealing off the second chamber and water reservoir from the environment. A hard seal 62 and soft seal 64 are also positioned between the top surface of the tray 40 and the pivoting plate 66 upon which the nozzles and Bombsight are mounted. The hard seal 62 is positioned about the nozzles and moves with the pivoting plate 66, and the soft seal 64 engages the tray soft seal 60 as the pivoting plate is moved between the dispensing and storage positions to maintain sealing. The seals prevent vapor from escaping from the second chamber 50 and the apparatus, thus maintaining the humid environment in the second chamber. With the dispenser nozzles in the dispense position, the second chamber 50 is sealed off to prevent unnecessary loss of humidity. In this position, a humidity sensor (FIG. 12 at 130) is exposed to the ambient environment and allows the system to generate vapor prior to the nozzles closing, thus reducing the time it will take for the colorant to be exposed to the correct humidity for retarding drying.

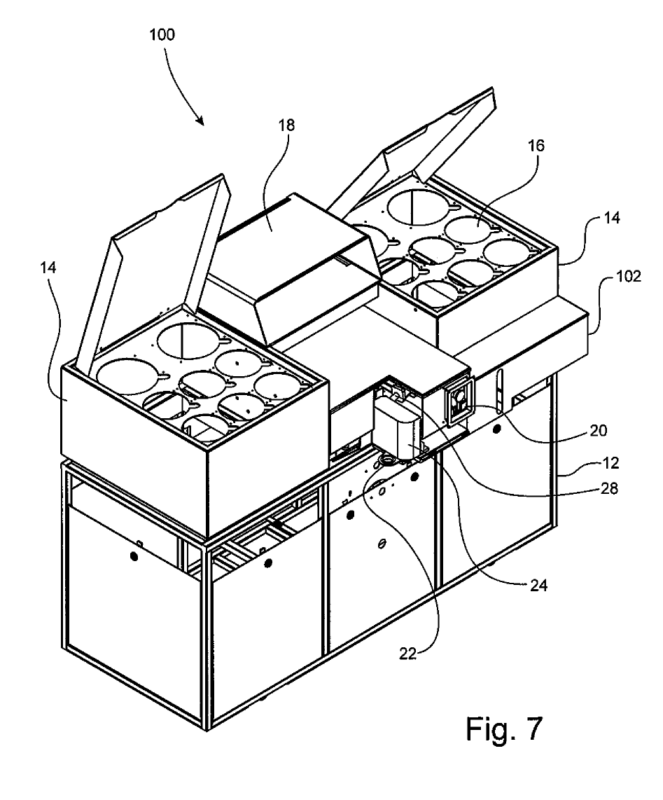

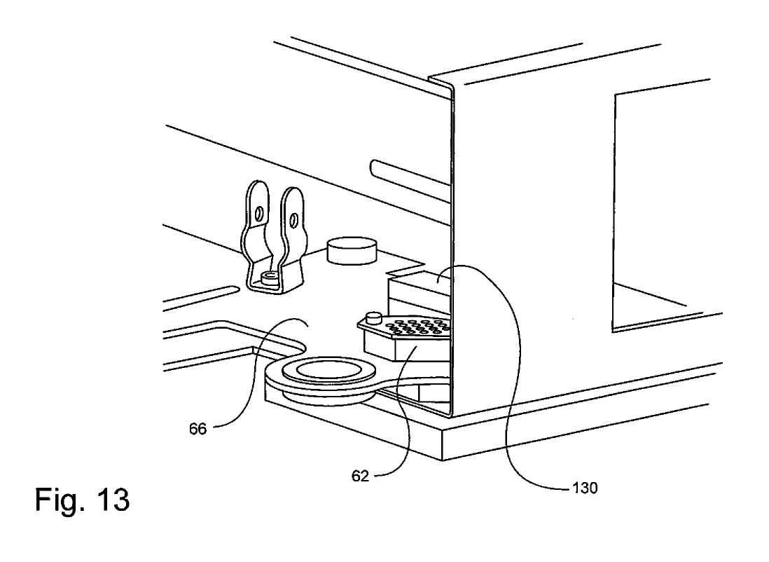

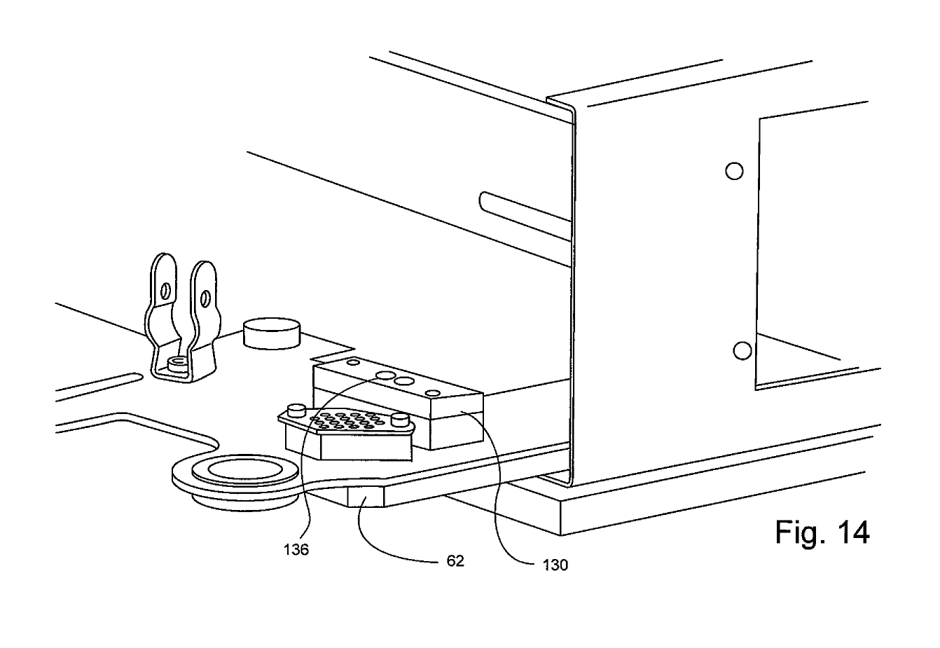

Referring to FIG. 7, a second embodiment of a colorant dispenser including a different humidity-generating apparatus is shown at 100. The dispenser also includes a body 12, canister bays 14, a computer shelf 18, a control panel 20, a container alignment feature 22 and a nozzle shroud 24. The humidity-generating apparatus 102 is mounted to the dispenser and creates a humid environment in which the nozzles are positioned between periods of use to prevent colorant at the nozzle tips from drying out. The apparatus 102 is shown mounted to the dispenser about the control panel and nozzle portions. Referring to FIGS. 12-14, the nozzles 104 are mounted on a pivoting plate 66 that moves the nozzles between a storage position shown in FIG. 13, and a dispensing position shown in FIG. 14. As in the previous embodiment, when in the storage position, the nozzle tips are exposed to the sealed chamber defined by the apparatus 102.

The humidity-generating apparatus 102 includes a housing 106 defining a water reservoir 108 for maintaining a volume of water for generating vapor. The water reservoir 108 includes a bulkhead 110 that divides the water reservoir into a supply section 112 and a vapor generating section 114. The bulkhead 110 is spaced apart from the bottom surface of the water reservoir to provide a gap 116 that allows the free flow of water from the supply section 112 into the vapor generating section 114. The vapor generating section 114 defines a volume sufficient to contain a vapor generating apparatus 118, for example, an ultrasonic Alpine Corp FG100 fogger or other suitable water vapor generating device. The relatively small volume of the vapor generating section 114 allows the production of a sufficient amount of vapor in much less time than if the vapor generating apparatus 118 had to fill the entire water reservoir 108 with vapor. The water reservoir 108 may be filled manually on a periodic basis to maintain sufficient water for efficient operation of the vapor generating apparatus 118, or may be automatically supplied with make-up water with a float device or other apparatus to maintain water within desired limits. The float may “trip” when the water reaches a certain height to shut-off incoming water.

A wall 120 spaced below the top of the water reservoir defines a passageway 122 down the side of the water reservoir to the sealed chamber 124 defined by the channel and walls and into the proximity of the nozzles 104. As vapor is generated and fills the vapor generating section 114, the vapor passively flows by gravity and its own inertia, aided by downdraft air flow through holes 126 defined in the lid 128 of the housing, and into the area of the dispenser nozzle to prevent exposed colorant at the nozzle tips from drying out between uses. The humid air flows through a percent relative humidity sensor 130, such as a Precon HC2000C humidity sensor, located near the nozzles 104. The vapor may flow into then out through flue holes 136 defined in the sensor holder, permitting an accurate determination of the humidity in the area. The sensor may be located anywhere along the flow path but is preferably located near the nozzles in their storage position to provide the most accurate reading.

Condensate from the vapor preferably drains away down a drain tube into a waste holding tank, not shown. The housing 106 defines a first lid 128 and a second lid 138 for providing access to the internal chambers of the housing. Seals may be positioned between the lids and the housing. The second lid 138 defines an opening 140 therethrough for allowing the vapor to pass through and contact the nozzle tips when the nozzle tips are in the storage position. The housing 106 may define a window 142 through a sidewall for viewing the water level in the water reservoir.

The vapor generating apparatus shown is a conventional ultrasonic fogger that includes a splash shield 144, an ultrasonic mister 146, and a float 148. The ultrasonic fogger is maintained at an optimum depth below the water surface in the reservoir by the float 148. The splash shield 144 is used to limit splatter. An ultrasonic fogger suitable for use in the present invention provides a continuous supply of moisture by vaporizing water with ultra high-frequency sound waves emitted through a transducer. The ultrasonic logger may include adjustable levels of output. While ultrasonic generation of the mist permits the use of cool or even chilled water, to minimize the growth of organisms in the water reservoir over time, other mechanisms, such as evaporators, steam generators or other devices may be used.

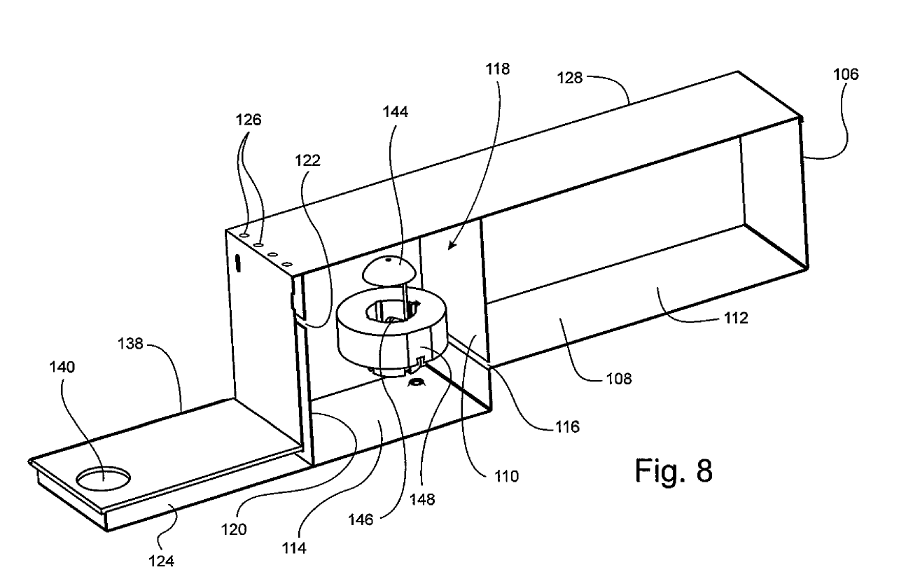

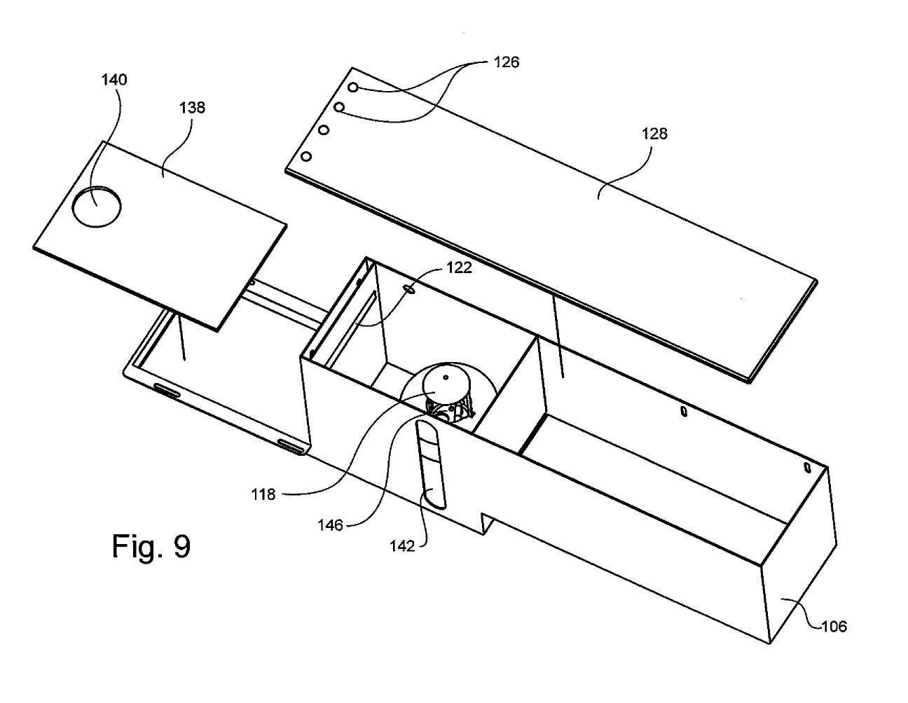

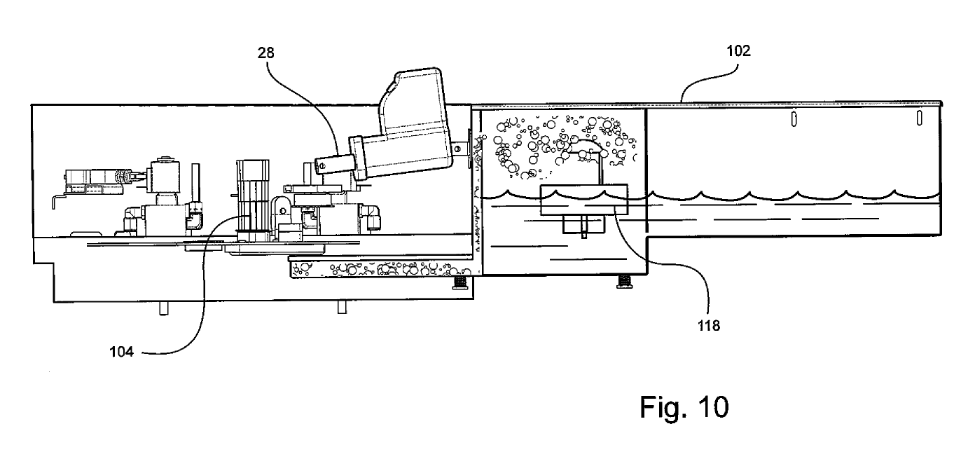

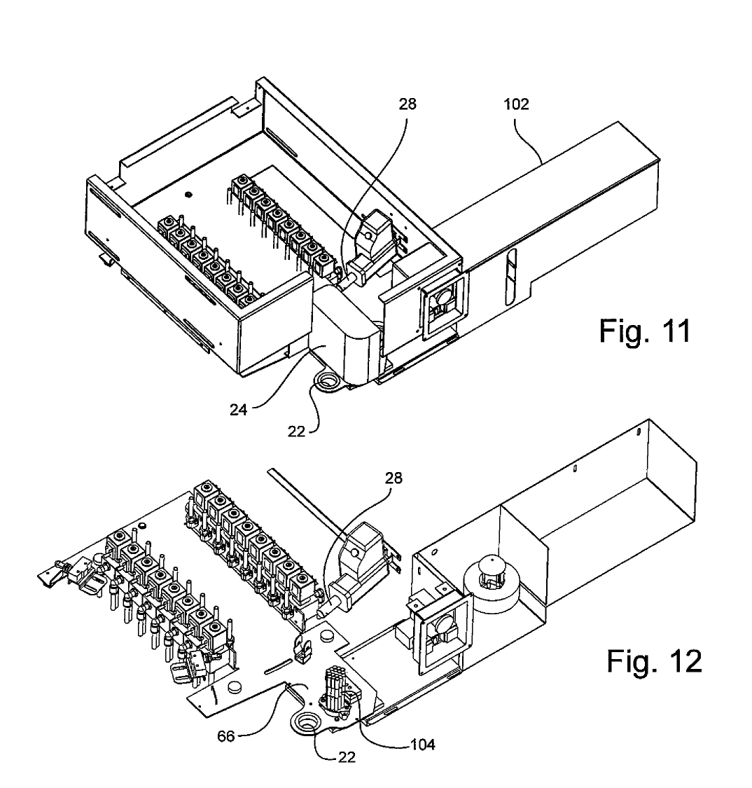

Referring to FIGS. 11-12 a portion of the colorant dispenser of FIG. 7 is shown with covering portions removed to illustrate the nozzles 104 and pivoting plate 66. The nozzles 104 are shown in the dispensing position and positioned over a container of base paint (not shown). When the pivoting plate 66 moves from the storage to the dispensing position, the opening (FIG. 8 at 140) to the sealed chamber is sealed off to prevent the vapor from escaping. When the pivoting plate 66 moves the nozzles 104 to the storage position between uses, the nozzles line-up over the opening and are exposed to the vapor. The vapor maintains a humid environment about the nozzle tips so that the water-based colorants do not dry out and clog the nozzles. The flow path of the vapor from the vapor generating portion to the sealed chamber is shown in FIG. 10.

With regard to both humidity-generating apparatus embodiments described herein, the colorant dispenser preferably includes a conventional closed-loop feedback circuit that receives humidity information from the humidity sensor 130 and controls the duty cycle of the vapor generating source (i.e., the heating source 42 or the vapor generating apparatus 118) to maintain the relative humidity at or about any set point. The closed loop circuit substantially reduces condensation while maintaining optimum conditions. The closed-loop system constantly monitors the humidity in the area of the nozzles and controls the vapor generated and conveyed to the area of the nozzle to maintain optimum humidity.

An improved apparatus and method for maintaining a humid environment in the immediate area of a colorant dispensing apparatus is described above. Various details of the invention may be changed without departing from the scope of the invention. Furthermore, the foregoing description of the preferred embodiment of the invention and best mode for practicing the invention are provided for the purpose of illustration only and not for the purpose of limitation.

What is claimed is:

1. An apparatus for providing vapor to at least one liquid dispensing nozzle to prevent liquid at the nozzle tip from drying out between uses, comprising:
a water source for supplying water;
a reservoir for maintaining a predetermined volume of the water;
a vapor generating source for generating vapor from the predetermined volume of water;
a chamber for maintaining the vapor; and
an opening defined through a chamber wall for exposing the at least one nozzle to the vapor when the at least one nozzle is in a storage position between uses.

2. The apparatus according to claim 1, wherein the opening is sealed when the at least nozzle is in a liquid dispensing position.

3. The apparatus according to claim 1, further comprising a relative humidity sensor for sensing the percent relative humidity and the temperature within the chamber.

4. The apparatus according to claim 3, further comprising a closed-loop feedback circuit for receiving an output from the sensor and controlling the output of the vapor generating source.

5. The apparatus according to claim 1, wherein the at least one liquid is a water-based colorant and the apparatus is mounted to a colorant dispenser.

6. The apparatus according to claim 1, wherein the water source is a water bottle containing a volume of water.

7. The apparatus according to claim 1, further comprising a bulkhead dividing the reservoir from the chamber.

8. The apparatus according to claim 1, wherein the vapor generating source is a heat source in thermal contact with the reservoir.

9. The apparatus according to claim 1, wherein the vapor generating source is an ultrasonic logger.

10. The apparatus according to claim 1, further comprising a flow path for the vapor from the vapor generating source to the chamber.

11. A colorant dispenser for precisely dispensing at least one colorant into a base paint, the colorant dispenser comprising:
at least one colorant dispensing nozzle;
a pivoting plate having the at least one nozzle mounted thereto and adapted to move between a colorant dispensing position and a storage position; and
an apparatus for providing vapor to the at least one nozzle in the storage position, the apparatus comprising:
a water source;
a reservoir for maintaining a predetermined volume of the water;
a vapor generating source for generating vapor from the predetermined volume of water;
a chamber for maintaining the vapor; and
an opening defined through a chamber wall for exposing the at least one nozzle to the vapor when the at least one nozzle is in the storage position between uses.

12. The colorant dispenser according to claim 11, wherein the vapor generating source is a heating source in thermal contact with the reservoir and/or its contents.

13. The colorant dispenser according to claim 11, wherein the vapor generating source is an ultrasonic fogger.

14. The colorant dispenser according to claim 11, further comprising a relative humidity sensor for determining the percent relative humidity within the chamber.

15. The colorant dispenser according to claim 14, further comprising a closed-loop feedback circuit for receiving an output from the sensor and controlling the output of the vapor generating source.

16. The colorant dispenser according to claim 1 1, wherein the apparatus for providing vapor further comprises a bulkhead dividing the reservoir from the chamber.

17. The colorant dispenser according to claim 1 1, wherein the chamber is sealed.

18. The colorant dispenser according to claim 11, wherein the apparatus for providing vapor further comprises a flow path from the vapor generating source to the chamber.
